(19) United States
(12) Patent Application Publication
(10) Pub. No.: US 2014/0137461 A1
(43) Pub. Date: May 22, 2014

(54) Fly-line Management Device

(71) Applicant: Christopher Adam DUVA, Portland, OR (US)

(72) Inventor: Christopher Adam DUVA, Portland, OR (US)

(21) Appl. No.: 14/079,061

(22) Filed: Nov. 13, 2013

Related U.S. Application Data
(60) Provisional application No. 61/727,227, filed on Nov. 16, 2012.

(51) Int. Cl. A01K 97/00; A01K 91/12

(52) U.S. Cl. CPC A01K 97/00; A01K 91/12
USPC 43/54.1

(57) ABSTRACT

A fly-line management device includes a mounting structure, a line holder brace, and a line holder. The mounting structure includes a support frame for bearing the line holder brace and a fastening strap and an end connector for attaching the mounting structure to a fishing rod. The line holder brace is connected to the support frame and retains the line holder. The line holder has a plurality of prongs in between which line is run by an angler to form loops of line as the line is stripped in to make a cast. The line is clamped in between each of the plurality of prongs with enough force as to hold the line in-place while setting up the cast, yet allow the line to be released passively during the final casting stroke. An outer coating may be utilized to alter the coefficient of friction of the plurality of prongs.

The current application claims a priority to the U.S. Provisional Patent application Ser. No. 61/727,227 filed on Nov. 16, 2012.

### FIELD OF THE INVENTION

The present invention relates generally to a fishing line management device. More specifically, the present invention is a device designed as an aid in fly-fishing and provides anglers with a quick and easy way to form, store, and release loops when fly-fishing.

### BACKGROUND OF THE INVENTION

Unlike conventional fishing, in fly-fishing the line to be cast is not stored on the reel between casts. Fly-fishers may have 10-70 feet of line off of the reel at a given time, typically floating in the water near them. This line has a tendency to get tangled and caught in the current, which impedes casting and limits the distance that the line can be cast. Fly-fishers must find a way to manage this line, which typically involves manually forming loops and holding them in the hands between casts. During the course of a long day of fishing this becomes very tiring and extremely tedious.

In an effort to address this issue, line management devices have been developed for fishermen. The most common line management device is a stripping basket. This is a basket-like device that the angler wears around his or her waist. When the line is stripped in between casts it is placed in the basket until the next cast is made. This type of device is used primarily in saltwater surf-casting and has no real application to two-handed (Spey) salmon and steelhead rods. The other principle form of line management device is a large container resembling a trash can that is placed on the deck of a boat. The line is stripped in between casts and stored in the container. It is used primarily in saltwater flats fishing and has no application to two-handed salmon rods.

Therefore it is the object of the present invention to provide a line management device for fly-fishing that allows anglers to form loops more efficiently than by hand and store them off of the water's surface, reducing friction and tangles. The present invention includes a mounting structure, a line holder brace, and a line holder. The mounting structure provides a means for attaching the present invention to a fishing rod and supports the line holder brace. The line holder is a comb-like device that allows the angler to simply run line between the prongs of the line holder in order to form and store loops of line as the angler strips in line to make a cast. The friction of the prongs provides enough force to hold the line in-place while setting up the cast, while at the same time allowing the line to be released passively during the final casting stroke. The line holder is removably attached to the line holder brace such that a line holder having differently sized prongs or differently spaced prongs may be interchanged in order to accommodate line of various diameters.

### BRIEF DESCRIPTION OF THE DRAWINGS

FIG. 1 is a perspective view of the fly-line management device.

FIG. 2 is a perspective view of the fly-line management device positioned against the handle of a fishing rod.

FIG. 3 is a perspective view of the fly-line management device attached to the handle of a fishing rod via the fastening strap and end connector.

FIG. 4 is an exploded perspective view of the fly-line management device.

FIG. 5 is a top plan view of the line holder brace.

FIG. 6 is a right side sectional view of the line holder.

FIG. 7 is a right side elevational view showing loops of fishing line being retained by the line holder of the fly-line management device

### DETAIL DESCRIPTIONS OF THE INVENTION

All illustrations of the drawings are for the purpose of describing selected versions of the present invention and are not intended to limit the scope of the present invention.

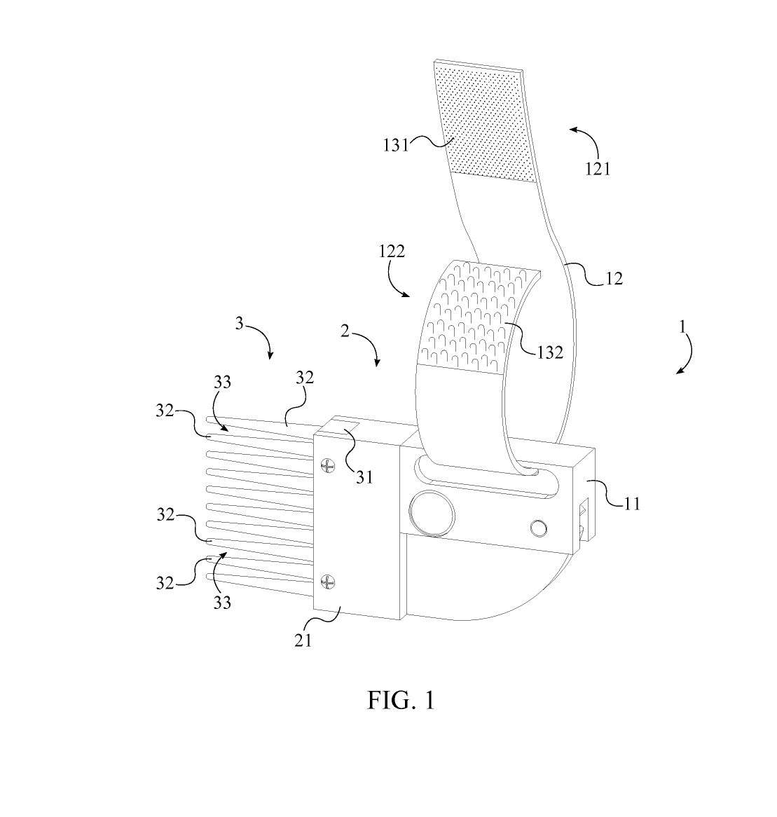

The present invention is a fly-line management device that allows users to readily form, store, and cast loops of fishing line. While the present invention is intended for use in the art of fly fishing with two-handed fly rods, it is to be known that the present invention can be used with any other type of fishing rod, such as one handed fly rods, and can be used in any other style of fishing. In reference to FIG. 1, the fly-line management device comprises a mounting structure 1, a line holder brace 2, and a line holder 3. The mounting structure 1 allows the fly-line management device to be attached to a fishing rod, while the line holder brace 2 is used to attach the line holder 3 to the mounting structure 1. The line holder 3 is the component of the present invention that allows the user to form, store, and cast loops of fishing line.

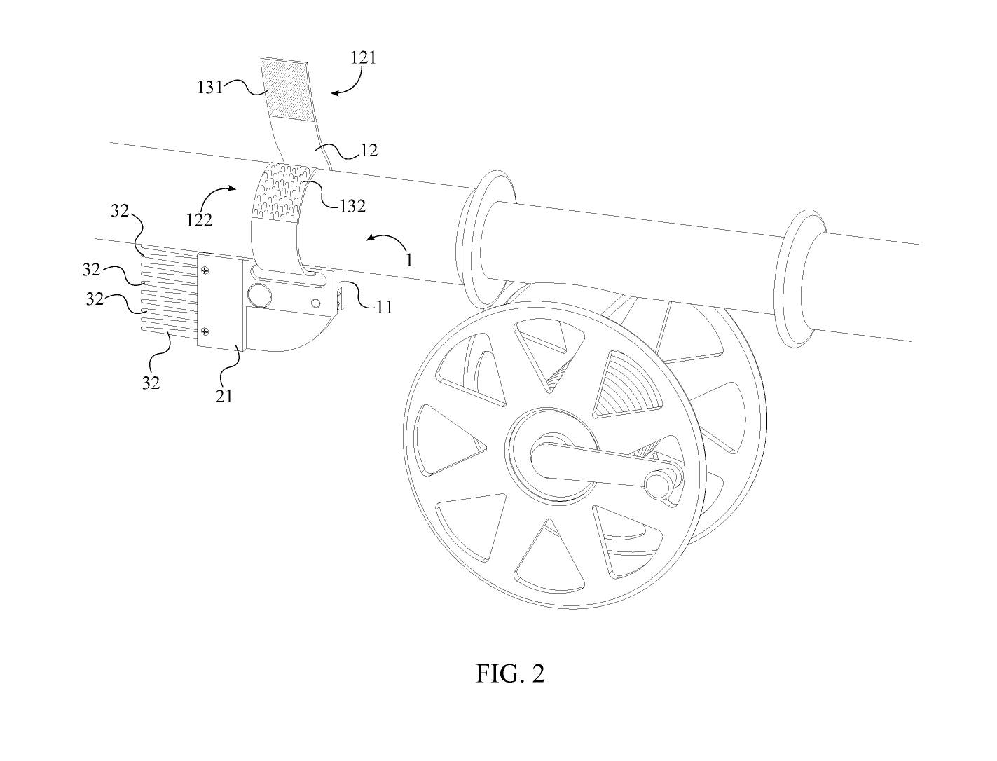

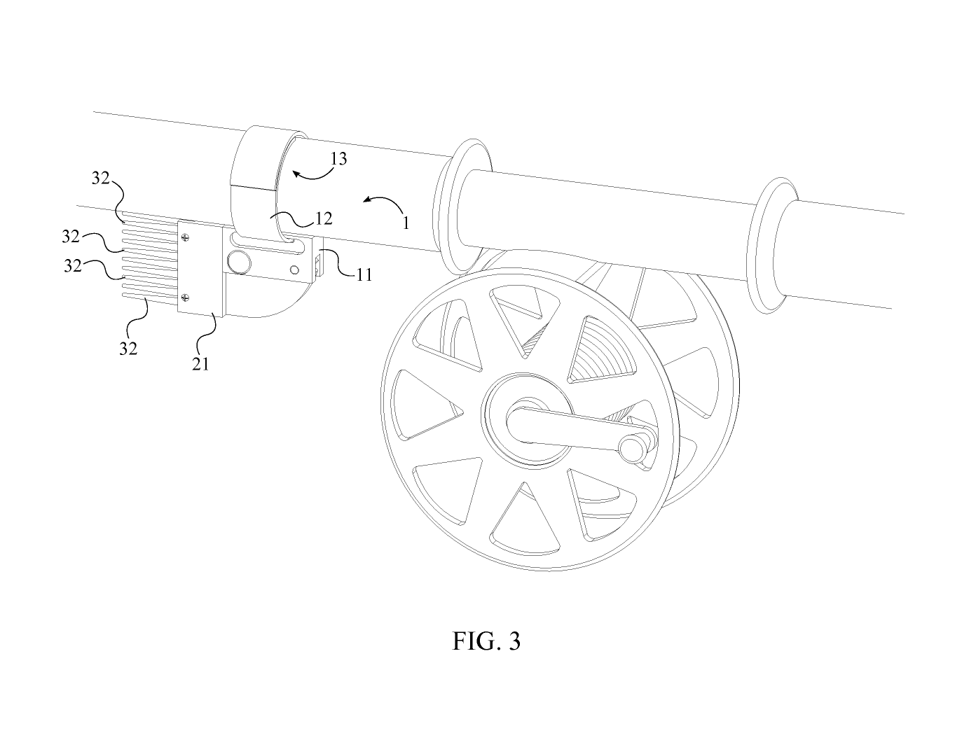

In reference to FIG. 2-3, the mounting structure 1 is attached to the handle of a fishing rod and supports the line holder brace 2. The mounting structure 1 comprises a support frame 11, a fastening strap 12, and an end connector 13. The support frame 11 forms the main body of the mounting structure 1 and is used to support the line holder brace 2 against the fishing rod. The fastening strap 12 is coupled to the support frame 11 and comprises a first end 121 and a second end 122, the first end 121 and the second end 122 being positioned opposite each other along the fastening strap 12. The fastening strap 12 is used in conjunction with the end connector 13 to secure the support frame 11 to the fishing rod. The end connector 13 is adjacently connected to the fastening strap 12 and is used to couple the first end 121 to the second end 122 in order to secure the fastening strap 12 around the handle of the fishing rod.

In further reference to FIG. 3, the fastening strap 12 is threaded through a slot cut through the support frame 11 and then wrapped around the handle of the fishing rod. The first end 121 is then coupled to the second end 122 by the end connector 13. In this way, the support frame 11 is coupled to the fastening strap 12 and securely held in place against the fishing rod handle. It is also possible for the fastening strap 12 to be coupled to the support frame 11 in any other manner, such as being directly and permanently connected to the support frame 11.

In the preferred embodiment of the present invention, the end connector 13 comprises a first fastener 131 and a second fastener 132, the first fastener 131 and the second fastener 132 being opposing hook and loop strip fasteners, as shown in FIG. 1. The first fastener 131 is positioned on the first end 121 of the fastening strap 12, while the second fastener 132 is positioned on the second end 122 of the fastening strap 12. Additionally, the first connector and the second connector are positioned on opposite sides of the fastening strap 12, such that when the fastening strap 12 is wrapped around the fishing rod handle, the first fastener 131 engages the second fastener 132. In this way, the first end 121 is coupled to the second end 122 in order to secure the fastening strap 12 around the fishing rod handle. It is also possible for the first fastener 131 and the second fastener 132 to compose any other type of fastening mechanism, such as the two interlocking discs of a snap fastener.

In other embodiments of the present invention, the end connector 13 may be only a single fastener, such as a screw clamp, buckle, or button. When the end connector 13 is a single fastener, the end connector 13 can be positioned on either the first end 121 or the second end 122. Depending on the type of fastener, one or more eyelets may be positioned along the fastening strap 12 opposite the end connector 13 in order to allow the first end 121 to be coupled to the second end 122. For example, if the end connector 13 is a buckle, then one or more eyelets are provided such that the catch of the buckle can traverse through the fastening strap 12 in order to couple the first end 121 to the second end 122.

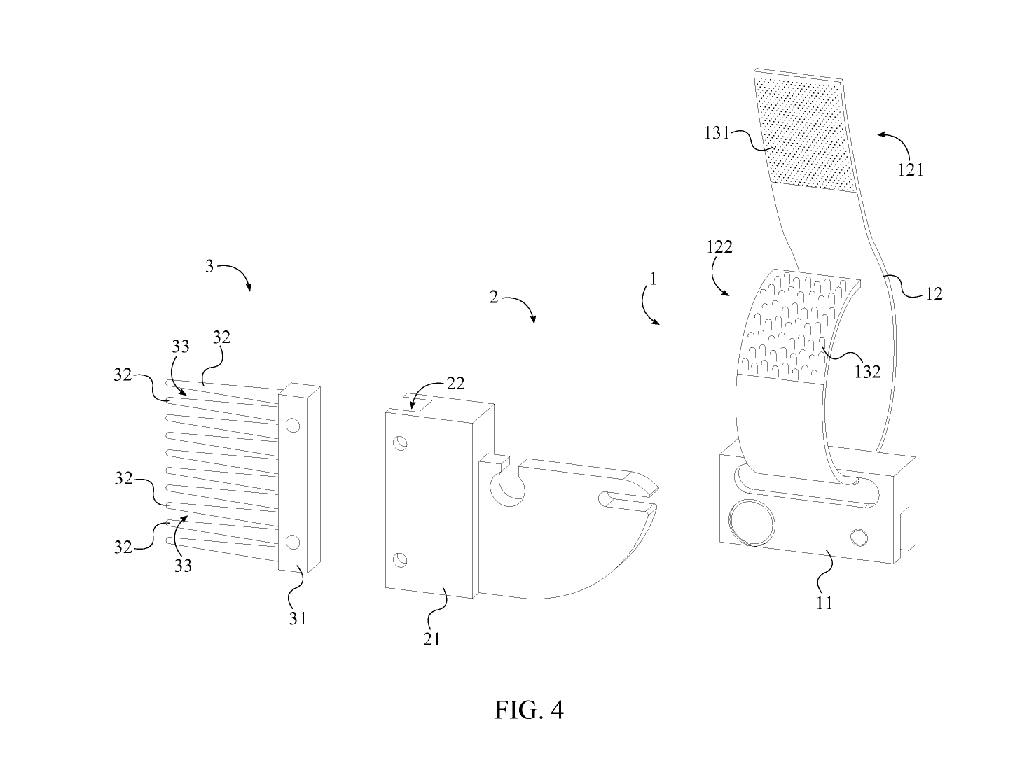

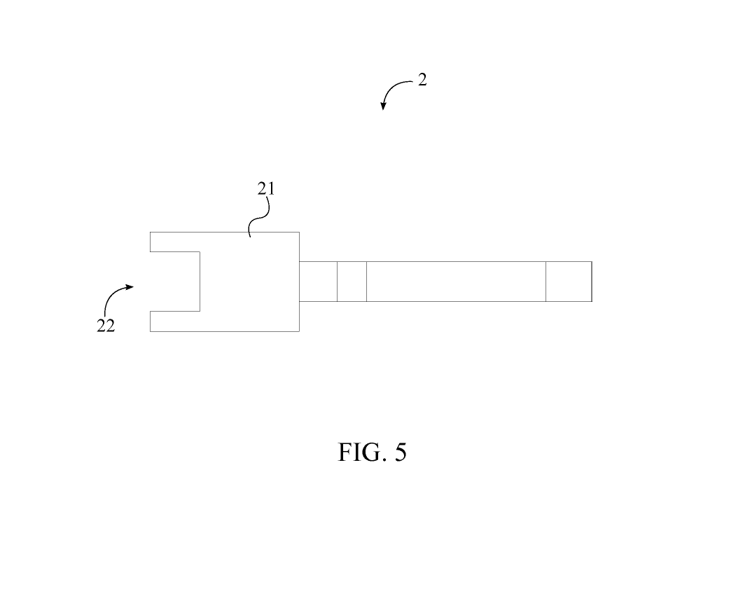

In reference to FIG. 1, the line holder brace 2 is used to secure the line holder 3 to the mounting structure 1. The line holder brace 2 comprises a brace frame 21 and a retention slot 22, as shown in FIG. 4. The brace frame 21 provides the body of the line holder brace 2 and is positioned adjacent to the support frame 11, while the retention slot 22 provides a means for receiving and retaining the line holder 3. The retention slot 22 is an elongated empty volume into which the line holder 3 is positioned in order to attach the line holder 3 to the line holder brace 2. The retention slot 22 laterally traverses into the brace frame 21 and is positioned along the brace frame 21, as shown in FIG. 5. In the preferred embodiment of the present invention, the brace frame 21 is permanently connected to the support frame 11, such that together the brace frame 21 and the support frame 11 form a single frame structure.

In reference to FIG. 4, the line holder 3 allows the user to form, store, and cast loops of fishing line and comprises a holder base 31, a plurality of prongs 32, and a plurality of open spaces 33. The holder base 31 supports the plurality of prongs 32 and is the component of the line holder 3 that is attached to the brace frame 21. The plurality of prongs 32 is adjacently connected to the holder base 31, with the plurality of open spaces 33 being positioned in between each of the plurality of prongs 32, wherein each of the plurality of open spaces 33 is an empty volume in which fishing line can be placed. The base holder is positioned within the retention slot 22 of the brace frame 21, with the plurality of prongs 32 being positioned along the holder base 31 opposite the brace frame 21, as shown in FIG. 1. Each of the plurality of prongs 32 is tapered starting from the holder base 31. The holder base 31 is removably attached to the brace frame 21 such that the line holder 3 can be interchanged with a subsequent line holder having the plurality of prongs 32 of a different size and/or the plurality of open spaces 33 of a different size. In this way, the fly-line management device is able to accommodate fishing line of various diameters.

In the preferred embodiment of the present invention, a plurality of holes is positioned into the brace frame 21 and through the holder base 31. The plurality of holes may be partially or fully threaded, such that a plurality of bolts can be threaded into the plurality of holes in order to secure the line holder 3 to the line holder brace 2. Alternatively, the plurality of holes can be smooth bored and a plurality of nuts can be threaded onto the plurality of bolts after the plurality of bolts has been inserted through the plurality of holes in order to secure the line holder 3 to the line holder brace 2. The line holder 3 can also be attached to the line holder brace 2 in any other way. For example, the holder base 31 can be snap fitted into the retention slot 22 or slid into the retention slot 22 and frictionally held in place.

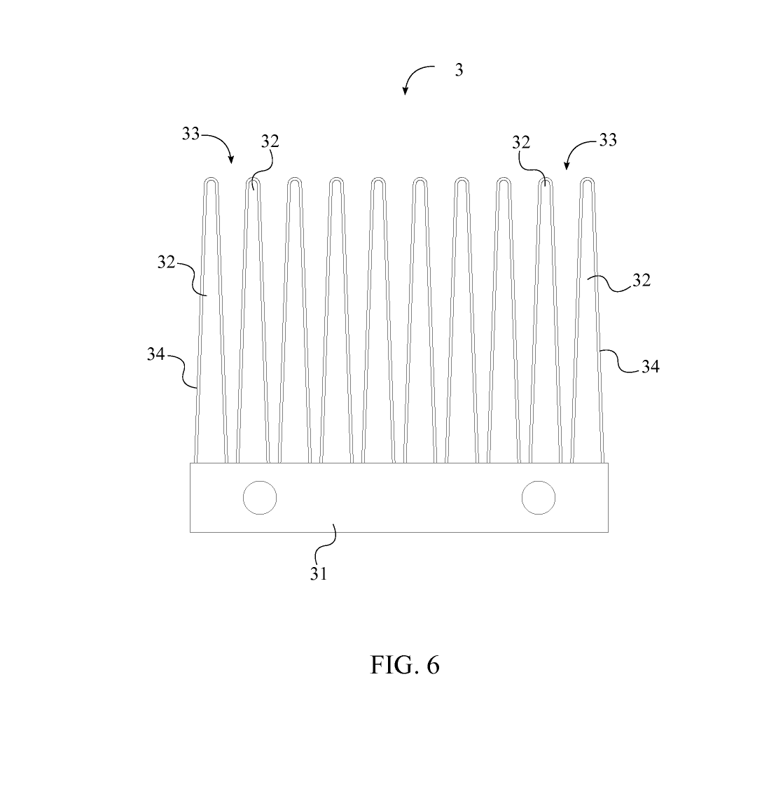

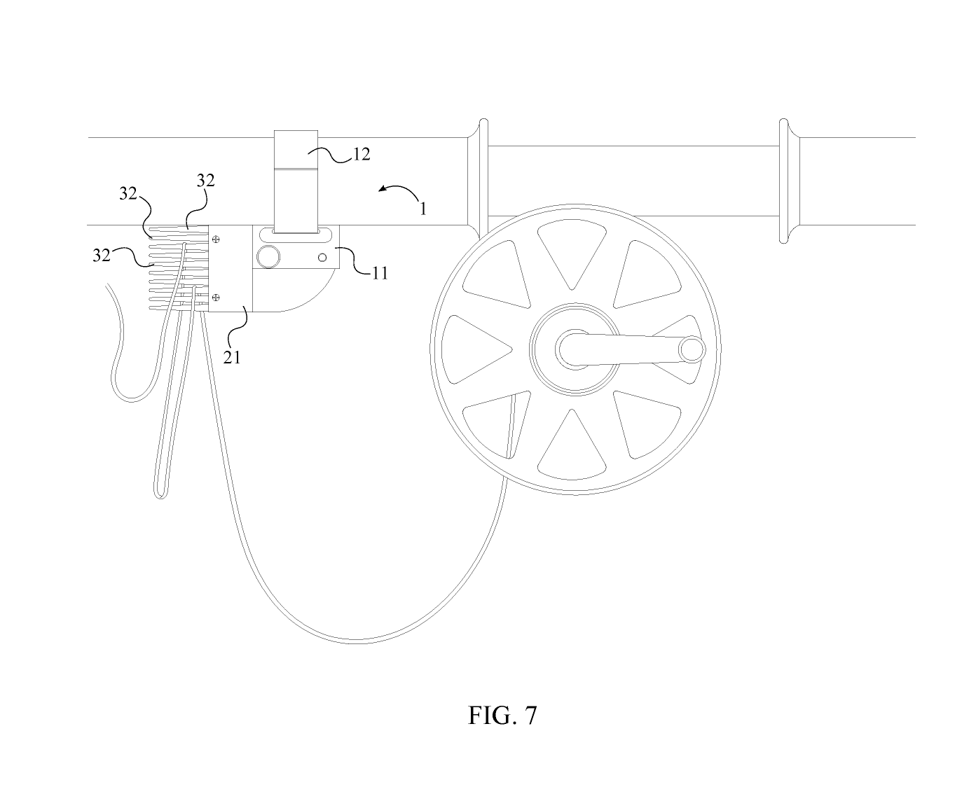

In reference to FIG. 7, fishing line is placed within the plurality of open spaces 33 and wedged between the plurality of prongs 32. Multiple loops can be formed in this manner, limiting one loop between each of the plurality of prongs 32 in order to prevent the fishing line from tangling. The plurality of prongs 32 are flexible and provide a clamping force to hold the fishing line in place when the fishing line is at rest, yet provide a low enough frictional force as to allow the fishing line to readily be dispensed when enough force is exerted in casting the fishing line. The line holder 3 may further comprise an outer coating 34 that encompasses the plurality of prongs 32, as show in FIG. 6. The outer coating 34 acts to reduce friction and aids in the release of the fishing line during the cast. Ideally the outer coating 34 is polytetrafluoroethylene, however, it is possible for any other material(s) to be used.

In an alternative embodiment of the present invention, the brace frame 21 is removably attached to the support frame 11. The mounting structure 1 further comprises a receiving slot, while the line holder brace 2 further comprises a brace flange. Similar to the retention slot 22 of the line holder brace 2, the receiving slot is an elongated section of empty space in which the brace flange is positioned in order to attach the line holder brace 2 to the support frame 11. The receiving slot laterally traverses into the support frame 11 and is positioned along the support frame 11 opposite the fastening strap 12. The brace flange is connected to the brace frame 21 opposite the retention slot 22 and is sized to fit within the receiving slot. The brace flange has a first open section and a second open section. The first open section is positioned along the brace flange opposite the brace frame 21 and allows the brace flange to be slotted along a cross member that is connected to the support frame 11 and positioned within the receiving slot. The second open section is positioned in between the brace frame 21 and the first open section and engages a locking member that is connected to the support frame 11 and positioned within the receiving slot. In this way, the brace flange is snapped into place within the receiving slot.

Alternatively, a plurality of holes can be positioned into the support frame 11 and through the brace flange. The plurality of holes may be partially or fully threaded, such that a plurality of bolts can be threaded into the plurality of holes in order to secure the line holder brace 2 to the mounting structure 1. The plurality of holes can also be smooth bored, such that a plurality of nuts can be threaded onto the plurality of bolts after the plurality of bolts has been inserted through the plurality of holes in order to secure the line holder brace 2 to the mounting structure 1.

The removable attachment of the brace frame 21 to the support frame 11 allows the user to more readily store the fly-line management device. For example, the user can remove the brace frame 21 while leaving the support frame 11 attached to the fishing rod handle. The fishing rod can then be stored in a case with the mounting structure 1 still attached, while the line holder brace 2 and line holder 3 are stored elsewhere.

Although the invention has been explained in relation to its preferred embodiment, it is to be understood that many other possible modifications and variations can be made without departing from the spirit and scope of the invention as hereinafter claimed.

What is claimed is:

1. A fly-line management device:
a mounting structure;
a line holder brace;
a line holder;
the mounting structure comprises a support frame;
the line holder brace comprises a brace frame;
the line holder comprises a holder base, a plurality of prongs, and a plurality of open spaces;
the brace frame being positioned adjacent to the support frame;
the plurality of prongs being adjacently connected to the holder base;
the plurality of open spaces being positioned in between each of the plurality of prongs;
the holder base being attached to the brace frame; and
the plurality of prongs being positioned along the holder base opposite the brace frame.

2. The fly-line management device as claimed in claim 1 comprises:
the brace frame being attached to the support frame.

3. The fly-line management device as claimed in claim 1 comprises:
the brace frame being connected to the support frame.

4. The fly-line management device as claimed in claim 1 comprises:
the line holder brace further comprises a retention slot;
the retention slot laterally traversing into the brace frame;
the retention slot being positioned along the brace frame; and
the holder base being positioned within the retention slot.

5. The fly-line management device as claimed in claim 1 comprises:
the line holder further comprises an outer coating; and
the outer coating encompassing the plurality of prongs.

6. The fly-line management device as claimed in claim 1 comprises:
the mounting structure further comprises a fastening strap;
the fastening strap comprises a first end and a second end;
the fastening strap being coupled to the support frame; and
the first end and the second end being positioned opposite each other along the fastening strap.

7. The fly-line management device as claimed in claim 6 comprises:
the mounting structure further comprises an end connector;
the end connector being adjacently connected to the fastening strap; and
the first end being coupled to the second end by the end connector.

8. The fly-line management device as claimed in claim 7 comprises:
the end connector comprises a first fastener and a second fastener;
the first fastener being positioned on the first end;
the second fastener being positioned on the second end; and
the first fastener engaging the second fastener.

9. A fly-line management device:
a mounting structure;
a line holder brace;
a line holder;
the mounting structure comprises a support frame, a fastening strap, and an end connector;
the line holder brace comprises a brace frame;
the line holder comprises a holder base, a plurality of prongs, and a plurality of open spaces;
the fastening strap comprises a first end and a second end;
the brace frame being positioned adjacent to the support frame;
the plurality of prongs being adjacently connected to the holder base;
the plurality of open spaces being positioned in between each of the plurality of prongs;
the holder base being attached to the brace frame;
the plurality of prongs being positioned along the holder base opposite the brace frame;
the fastening strap being coupled to the support frame;
the first end and the second end being positioned opposite each other along the fastening strap; and
the end connector being adjacently connected to the fastening strap.

10. The fly-line management device as claimed in claim 9 comprises:
the brace frame being attached to the support frame.

11. The fly-line management device as claimed in claim 9 comprises:
the brace frame being connected to the support frame.

12. The fly-line management device as claimed in claim 9 comprises:
the line holder brace further comprises a retention slot;
the retention slot laterally traversing into the brace frame;
the retention slot being positioned along the brace frame; and
the holder base being positioned within the retention slot.

13. The fly-line management device as claimed in claim 9 comprises:
the line holder further comprises an outer coating; and
the outer coating encompassing the plurality of prongs.

14. The fly-line management device as claimed in claim 9 comprises:
the first end being coupled to the second end by the end connector.

15. The fly-line management device as claimed in claim 14 comprises:
the end connector comprises a first fastener and a second fastener;
the first fastener being positioned on the first end;
the second fastener being positioned on the second end; and
the first fastener engaging the second fastener.

16. A fly-line management device:
a mounting structure;
a line holder brace;
a line holder;
the mounting structure comprises a support frame, a fastening strap, and an end connector;
the line holder brace comprises a brace frame and a retention slot;
the line holder comprises a holder base, a plurality of prongs, and a plurality of open spaces;
the fastening strap comprises a first end and a second end;
the end connector comprises a first fastener and a second fastener;
the brace frame being positioned adjacent to the support frame;
the retention slot laterally traversing into the brace frame;
the retention slot being positioned along the brace frame;
the plurality of prongs being adjacently connected to the holder base;
the plurality of open spaces being positioned in between each of the plurality of prongs;
the holder base being attached to the brace frame;
the holder base being positioned within the retention slot;
the plurality of prongs being positioned along the holder base opposite the brace frame;
the fastening strap being coupled to the support frame;
the first end and the second end being positioned opposite each other along the fastening strap;
the end connector being adjacently connected to the fastening strap;
the first fastener being positioned on the first end; and
the second fastener being positioned on the second end.

17. The fly-line management device as claimed in claim 16 comprises:
the brace frame being attached to the support frame.

18. The fly-line management device as claimed in claim 16 comprises:
the brace frame being connected to the support frame.

19. The fly-line management device as claimed in claim 16 comprises:
the line holder further comprises an outer coating; and
the outer coating encompassing the plurality of prongs.

20. The fly-line management device as claimed in claim 16 comprises:
the first end being coupled to the second end by the end connector; and
the first fastener engaging the second fastener.
